(19) United States
(12) Patent Application Publication
(10) Pub. No.: US 2006/0253224 A1
(43) Pub. Date: Nov. 9, 2006

(54) Self-guided cleaning robot, self-guided robot, and program product for performing method for controlling travel of self-guided robot

(75) Inventors: Takao Tani, Daito-shi (JP); Hiroyuki Takenaka, Daito-shi (JP)

Correspondence Address: OSHA LIANG L.L.P., 1221 MCKINNEY STREET, SUITE 2800, HOUSTON, TX, 77010, US

(73) Assignee: Funai Electric Co., Ltd., Daito-shi (JP)

(21) Appl. No.: 11/430,362

(22) Filed: May 9, 2006

(30) Foreign Application Priority Data
May 9, 2005 (JP) 2005-135752

(51) Int. Cl. G06F 19/00

(52) U.S. Cl. 700/245; 701/23

(57) ABSTRACT

A self-guided robot for traveling with a predetermined traveling pattern includes a gyro sensor for detecting an angle indicative of a traveling direction from a reference position, a left rotary encoder and a right rotary encoder for detecting a traveling distance from the reference position, left and right driving wheels for allowing a main body to move, and a left driving wheel motor and a right driving wheel motor for driving the left and right driving wheels for travel. A CPU calculates a deviation amount from a planned route on the basis of detection amounts from gyro sensor, left rotary encoder and right rotary encoder, and controls the driving of left driving wheel motor and right driving wheel motor on the basis of the calculated deviation amount.

### BACKGROUND OF THE INVENTION

1. Field of the Invention

The present invention relates to a self-guided cleaning robot, a self-guided robot, and a program product for performing a method for controlling travel of the self-guided robot. In particular, the present invention relates to a self-guided cleaning robot, a self-guided robot, and a program product for performing a method for controlling travel of the self-guided robot, which can detect an angle and a traveling distance.

2. Description of the Background Art

In recent years, there has been developed a self-guided robot for traveling with a predetermined traveling pattern while performing a cleaning operation and the like. This type of self-guided robot can perform a predetermined operation by traveling along a traveling route determined by the traveling pattern. However, in practice, the robot may travel in a direction deviating from a target direction under an influence of texture of a carpet in some cases. In order to correct such deviation, various propositions have been made.

There is a mobile work robot for working while traveling and compensating for the influence of the texture of the carpet as disclosed in Japanese Laid-Open Patent Publication No. 07-116087. There is also a mobile work robot capable of automatically detecting the influence of the texture of the carpet as disclosed in Japanese Laid-Open Patent Publication No. 05-061540. There is an autonomously traveling vehicle for calculating an error between an actual angle calculated from data from a gyro sensor and a target angle and performing a process for correcting the angle by a turn correcting amount as disclosed in Japanese Laid-Open Patent Publication No. 10-240342.

As a technique for eliminating areas left without being traveled (areas left without being cleaned) with a minimum necessary traveling distance, there is an autonomously traveling robot for traveling autonomously and faithfully to a predetermined traveling mode in a traveling space which the robot has recognized in advance by orbiting in the space as disclosed in Japanese Laid-Open Patent Publication No. 05-046239.

Moreover, there is continuous and accurate detection of a position of a mobile object by two position detectors which complement each other as disclosed in Japanese Laid-Open Patent Publication No. 08-211934.

However, in any of the above documents, return to a predetermined traveling route (a route programmed to be traveled) when the robot or vehicle deviates from the target direction is not disclosed at all.

For example, in Japanese Laid-Open Patent Publication No. 07-116087, though a main body can be reoriented straight, the mobile work robot travels in a direction parallel to a target direction on a route programmed to be traveled. As a result, the robot travels in a course deviating from the route programmed to be traveled and there may be some areas left without being traveled (cleaned).

### SUMMARY OF THE INVENTION

The present invention has been made to solve the aforementioned problems and aims to provide a self-guided cleaning robot, a self-guided robot, and a program product for performing a method for controlling travel of the self-guided robot with enhanced straight-ahead traveling performance.

According to an aspect of the present invention, a self-guided cleaning robot travels with a predetermined traveling pattern, and includes a suction unit, an angle detection unit, a distance detection unit, a travel unit, a traveling drive unit, a route deviation amount calculation unit and a traveling control unit. The suction unit performs a sucking operation for cleaning. The angle detection unit is a device for detecting an angle indicative of a traveling direction from a reference position. The distance detection unit is a device for detecting a traveling distance from the reference position. The travel unit allows a main body to move. The traveling drive unit drives the travel unit for traveling. The route deviation amount calculation unit calculates a route deviation amount from a planned route when the traveling pattern is a straight-ahead traveling pattern for traveling along the planned route. The route deviation amount calculation unit includes an acquisition unit for acquiring detection amounts every predetermined time from the angle detection unit and the distance detection unit, respectively, and an axis deviation amount calculation unit for calculating an axis deviation amount from a planned axis for the every predetermined time on the basis of the acquired detection amounts, and successively adds the axis deviation amount to calculate the route deviation amount. A traveling control unit controls the driving of the traveling drive unit on the basis of the calculated route deviation amount. The traveling control unit includes a determination unit for determining a type of a sign of the route deviation amount, and a setting unit for setting a rotation angle for traveling toward the planned route on the basis of the type of the sign, and controls the driving of the traveling drive unit according to the set rotation angle.

The “planned route” is a route programmed to be traveled and representing a route from a start point to a target point with a straight line. The “planned axis” represents a straight line parallel to the planned route with reference to the reference position.

According to another aspect of the present invention, a self-guided robot includes an angle detection unit, a distance detection unit, a travel unit, a traveling drive unit, a route deviation amount calculation unit and a traveling control unit. The angle detection unit is a device for detecting an angle indicative of a traveling direction from a reference position. The distance detection unit detects a traveling distance from the reference position. The travel unit is a device for allowing a main body to move. The traveling drive unit drives the travel unit for travel. The route deviation amount calculation unit calculates a route deviation amount from a planned route on the basis of detection amounts from the angle detection unit and the distance detection unit when the traveling pattern is a straight-ahead traveling pattern for traveling along the planned route. The traveling control unit controls the driving of the traveling drive unit on the basis of the calculated route deviation amount.

Preferably, the self-guided robot further includes a suction unit for performing a sucking operation for cleaning.

Preferably, the route deviation amount calculation unit includes an acquisition unit for acquiring detection amounts every predetermined time from the angle detection unit and the distance detection unit, respectively, and an axis deviation amount calculation unit for calculating an axis deviation amount from a planned axis for the every predetermined time on the basis of the acquired detection amounts, and successively adds the axis deviation amount to calculate the route deviation amount.

Preferably, the traveling control unit includes a type determination unit for determining a type of a first sign of the route deviation amount calculated by the route deviation amount calculation unit.

Preferably, the traveling control unit further includes a setting unit for setting a rotation angle for traveling toward the planned route on the basis of the type of the first sign determined by the type determination unit, and controls the driving of the traveling drive unit according to the set rotation angle.

Preferably, the traveling control unit further includes a determination unit for determining whether or not the type of a second sign of the axis deviation amount is the same as the type of the first sign, and an increase processing unit for increasing a rotation angle for traveling toward the planned route when the determination unit determines that the type of the first sign and the type of the second sign are the same, and controls the driving of the traveling drive unit according to the increased rotation angle.

Preferably, the travel unit includes a left travel unit provided to a left side of the main body and a right travel unit provided to a right side of the main body, the traveling drive unit includes a left traveling drive unit for driving the left travel unit and a right traveling drive unit for driving the right travel unit, and the traveling control unit changes a driving state of either one of the left traveling drive unit and the right traveling drive unit.

Preferably, the angle detection unit includes a gyro sensor, and the distance detection unit includes a rotary encoder provided in the traveling drive unit.

According to still another aspect of the present invention, a program product performs a method for controlling travel of a self-guided robot, and the method includes the steps of: acquiring every predetermined time an angle indicative of a traveling direction from a reference position and a traveling distance from the reference position, respectively, when the traveling pattern of the self-guided robot is a straight-ahead traveling pattern for traveling along a planned route; calculating an axis deviation amount from a planned axis for the every predetermined time on the basis of the angle and the traveling distance, the planned axis representing a straight line parallel to the planned route with reference to the reference position; calculating a route deviation amount from the planned route by successively adding the axis deviation amount; determining a type of a sign of the route deviation amount; and setting a rotation angle for traveling toward the planned route on the basis of the type of the sign of the route deviation amount to control the driving of a traveling drive unit according to the set rotation angle.

According to the present invention, control of a traveling drive system is performed on the basis of the deviation amount from the planned route. Therefore, it is possible to constantly perform travel kept in the planned route. As a result, it is possible to enhance performance of the straight-ahead travel of the self-guided robot.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an outer appearance perspective view of a cleaner in an embodiment of the present invention;

FIG. 2 is a sectional view taken along line II-II of FIG. 1;

FIG. 3 is a block diagram showing a configuration of the cleaner in the embodiment of the present invention;

FIG. 4 is a flowchart showing a flow of straight-ahead travel controlling processes performed by a CPU in the cleaner in the embodiment of the present invention;

FIG. 5 shows a principle of calculation of a deviation amount Ws;

FIG. 6 is a flowchart of a leftward n° correcting process shown in step S14 in FIG. 4;

FIG. 7 is a flowchart of a rightward n° correcting process shown in step S16 in FIG. 4;

FIGS. 8A and 8B illustrate a traveling method for achieving a straight-ahead traveling control in the embodiment of the present invention;

FIG. 9 is a first view for concretely describing the straight-ahead traveling control in the embodiment of the present invention; and

FIG. 10 is a second view for concretely describing the straight-ahead traveling control in the embodiment of the present invention.

### DESCRIPTION OF THE PREFERRED EMBODIMENTS

Description will be given of an embodiment of the present invention in detail with reference to the drawings. In the drawings, like reference characters refer to like or corresponding elements and description thereof will not be repeated.

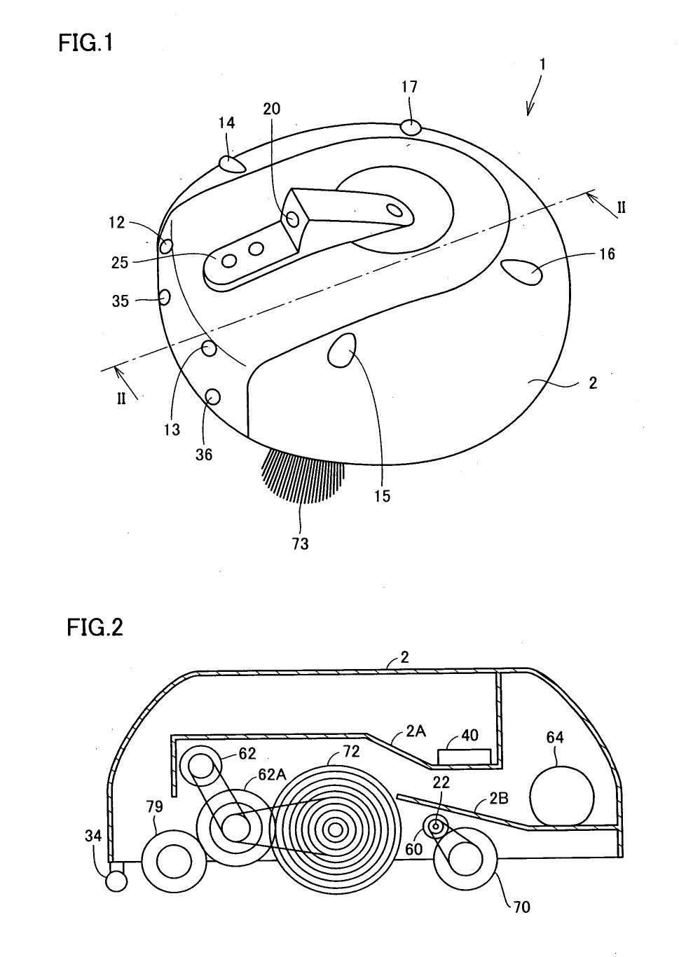

FIG. 1 is an outer appearance perspective view of a self-guided cleaning robot (hereinafter, referred to as “cleaner”) 1 according to the embodiment of present invention.

With reference to FIG. 1, cleaner 1 whose exterior part is covered with an outer jacket 2 and has an almost disc shape. A camera 20, an input unit 25 and proximity sensors 12 to 17 are provided on outer jacket 2. Camera 20 is provided on an almost center of a top face of outer jacket 2 so as to face obliquely upward in a traveling direction. Input unit 25 is configured by switches and the like, and is used when a user inputs information to cleaner 1. Each of proximity sensors 12 to 17 takes a form of, for example, an infrared sensor to sense presence/absence of an obstacle and a distance to the obstacle.

In addition, LEDs (Light Emitting Diodes) 35 and 36 for compensating an illumination upon image capturing by camera 20 are provided below proximity sensors 12 and 13 provided on a front face of outer jacket 2, respectively. Further, a plurality of LEDs (not shown) are also provided below LEDs 35 and 36. Thus, it is possible to detect presence/absence of a floor face.

A bumper (not shown) is provided on a lower portion of the front face of outer jacket 2 in order to further ensure security. Thus, for example, if the user puts his/her hand in a lower portion of the main body during traveling, it is possible to stop the main body.

Cleaner 1 includes side brushes 73 provided below both sides of outer jacket 2 in front thereof. Side brushes 73 enable to collect dust inwardly.

It is to be noted that FIG. 1 shows proximity sensors 12 to 17 as a sensor for sensing presence/absence of an obstacle and a distance to the obstacle; however, a plurality of any other sensors may be provided in addition to proximity sensors 12 to 17.

FIG. 2 is a sectional view of cleaner 1 taken along line II-II of FIG. 1.

With reference to FIG. 2, support plates 2A and 2B are provided inside outer jacket 2. On support plate 2A, there is provided a control unit 40 into which components for controlling operations of cleaner 1 are incorporated. On an almost center portion of cleaner 1, there is provided a main brush 72 for sweeping dust on a floor face while rotating. When a main brush motor 62 is driven, a driving force from main brush motor 62 is transmitted to main brush 72 through a gear 62A; thus, main brush 72 rotates. The dust swept by main brush 72 is collected in a dust collection cup (not shown). When a suction motor 64 is driven, the swept dust passes through a nozzle (not shown) and, then, is introduced into the dust collection cup. Suction motor 64 is provided on support plate 2B.

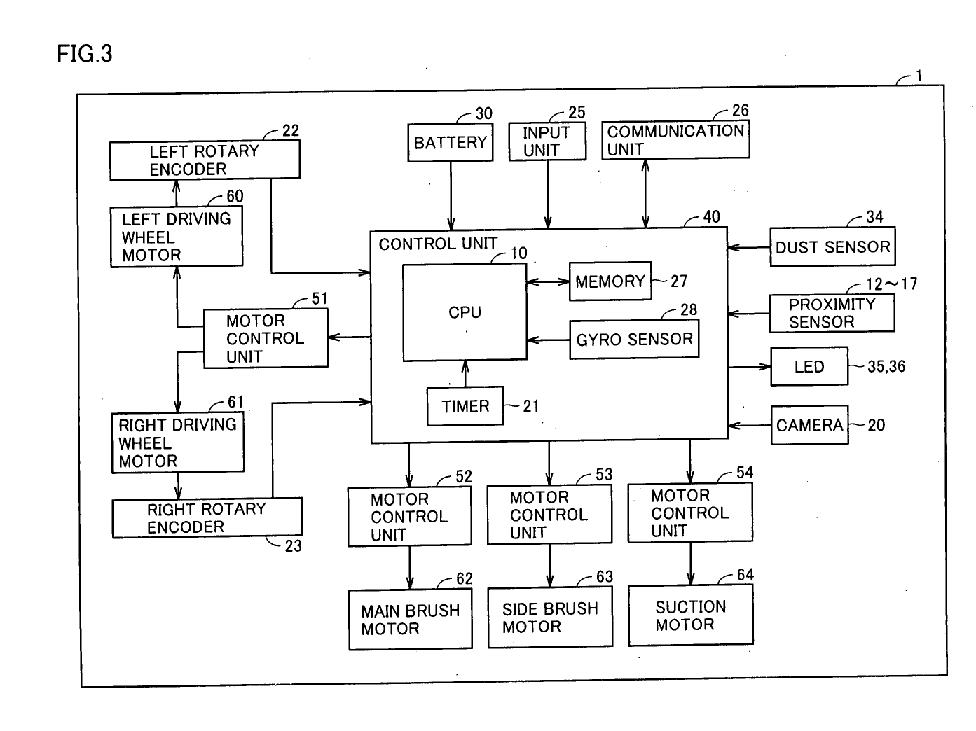

FIG. 2 shows a left driving wheel 70. Cleaner 1 includes left driving wheel 70 and a right driving wheel (not shown) respectively provided on both sides thereof These two driving wheels are driven, so that cleaner 1 travels. When a left driving wheel motor 60 is driven, left driving wheel 70 rotates. Left driving wheel motor 60 is provided with a left rotary encoder 22 for detecting a traveling distance. It is to be noted that a right driving wheel motor 61 (see FIG. 3) is also provided with a right rotary encoder 23 (see FIG. 3) for detecting a traveling distance. As described above, cleaner 1 is provided with rotary encoders capable of detecting a traveling distance, that is, a moving amount, independently of the right and left driving wheel motors.

Cleaner 1 further includes auxiliary wheels respectively provided rearward the left and right driving wheels. An auxiliary wheel 79 is provided rearward left driving wheel 70. Cleaner 1 includes a dust sensor 34 provided at a rear end portion thereof Dust sensor 34 is a unit including an infrared sensor, and senses an amount of dust on a floor face.

FIG. 3 shows a block configuration of cleaner 1.

As described above, cleaner 1 includes proximity sensors 12 to 17, camera 20, left rotary encoder 22, right rotary encoder 23, input unit 25, LEDs 35, 36, left driving wheel motor 60, right driving wheel motor 61, main brush motor 62, and suction motor 64. In addition, cleaner 1 includes a CPU (Central Processing Unit) 10 for performing various arithmetic operations and control operations, a timer 21 for measuring a time, a communication unit 26 for communicating with an external device, a memory 27 for storing data and programs, a sensor for detecting an angle at which the main body is directed, i.e., a moving direction, e.g., a gyro sensor 28, a chargeable battery 30, and a side brush motor 63 for driving side brushes 73. Further, cleaner 1 includes a motor control unit 51 for controlling left driving wheel motor 60 and right driving wheel motor 61, a motor control unit 52 for controlling the driving of main brush motor 62, a motor control unit 53 for controlling the driving of side brush motor 63, and a motor control unit 54 for controlling the driving of suction motor 64.

In this embodiment, for example, CPU 10, timer 21, memory 27 and gyro sensor 28 are incorporated into control unit 40 (see FIG. 2).

For example, a wireless LAN card is inserted into communication unit 26. Thus, it is possible to establish wireless communication with an external device.

CPU 10 receives information inputted through input unit 25. In addition, CPU 10 receives detection signals from dust sensor 34, proximity sensors 12 to 17, left rotary encoder 22, right rotary encoder 23 and gyro sensor 28. Further, CPU 10 receives data of an image captured by camera 20. CPU 10 can refer to a time measured by timer 21. CPU 10 can control operations of LED 35. CPU 10 writes and reads data into and from memory 27. CPU 10 is connected to motor control units 51 to 54.

Left rotary encoder 22 and right rotary encoder 23 detect pulses generated as left driving wheel 70 and the right driving wheel (not shown) rotate, respectively.

Gyro sensor 28 detects an angular velocity (°/sec) as cleaner 1 travels.

Here, cleaner 1 in the embodiment of the present invention performs map cleaning based on the input signal from input unit 25, for example. “Mapped cleaning” is cleaning in which CPU 10 allows cleaner 1 to travel with a predetermined traveling pattern while at least referring to cleaning region information (hereinafter, referred to as “map”) stored in memory 27, preferably cleaning in which CPU 10 allows cleaner 1 to travel while mapping (creating the map) and referring to the map.

Cleaner 1 can also be operated by a timer so that cleaner 1 starts to perform cleaning at a designated time. More specifically, when information for designating the time to start cleaning is inputted through input unit 25, cleaner 1 can start to perform a cleaning operation on condition that a time counted by timer 21 becomes the designated time.

Cleaner 1 can execute an operation for security, in addition to the cleaning operation. More specifically, for example, when a time for executing a security operation and information for designating a traveling pattern are inputted through input unit 25, cleaner 1 executes a patrol operation by driving motor control unit 51 so as to travel with the designated traveling pattern, on condition that the time measured by timer 21 becomes the designated time. In the case where cleaner 1 executes such a security operation, if proximity sensors 12 to 17 sense presence or motion of an object or person, which is not assumed ordinarily, camera 20 captures an image of the object or person and, then, the captured image can be transmitted to a predetermined terminal placed away from cleaner 1 through communication unit 26.

Hereinafter, description will be given of processes performed by CPU 10 in the map cleaning.

CPU 10 performs cleaning process and travel controlling process in the map cleaning. As the cleaning process, in order to rotate main brush 72 and side brushes 73, a driving current is supplied to main brush motor 62 and side brush motor 63 through motor control units 52 and 53. Further, in order to suck the dust collected by these brushes, a driving current is supplied to suction motor 64 through motor control unit 54.

As the travel controlling process, in order to allow the cleaner 1 to travel with the predetermined traveling pattern on the basis of the map stored in memory 27, and detection signals from left rotary encoder 22, right rotary encoder 23 and gyro sensor 28, the driving of left driving wheel motor 60 and right driving wheel motor 61 is controlled through motor control unit 51. More specifically, PWM (Pulse Width Modulation) control is performed over left driving wheel motor 60 and right driving wheel motor 61 through motor control unit 51. In other words, CPU 10 gives motor control unit 51 pulse duties for driving left driving wheel motor 60 and right driving wheel motor 61, respectively. Then, motor control unit 51 drives respective driving wheel motors 60 and 61 on the basis of the given pulse duties for a unit time T (e.g., 40 ms) to thereby achieve control of a traveling speed and a traveling direction.

Here, the aforementioned predetermined traveling pattern includes, for example, so-called zigzag traveling in which a route is changed little by little while repeating a straight ahead movement and a 180°-turn movement (reciprocating). In this way, CPU 10 can repeatedly perform traveling control according to a straight-ahead traveling pattern and traveling control according to a turn traveling pattern in the map cleaning. By repeatedly performing such traveling control, it is possible to prevent an uncleaned region from remaining.

However, even when the traveling control according to the straight-ahead traveling pattern is being performed by CPU 10, cleaner 1 may proceed in a direction deviating from the planned route under the influence of the texture of the carpet and the like. In this case, a region corresponding to the deviation from the planned route is left without being cleaned and it is impossible to achieve accurate cleaning. From this point, to enhance straight-ahead traveling performance to perform travel along the planned route is considered to be the way to reduce the region left without being cleaned.

Therefore, CPU 10 in the embodiment of the present invention performs traveling control (straight-ahead movement control) which will be described below in the case of the straight-ahead traveling pattern.

The “planned route” refers to a traveling route programmed to be traveled in the case of the straight-ahead traveling pattern. More specifically, it refers to the traveling route representing a route from a start point to a target point with a straight line.

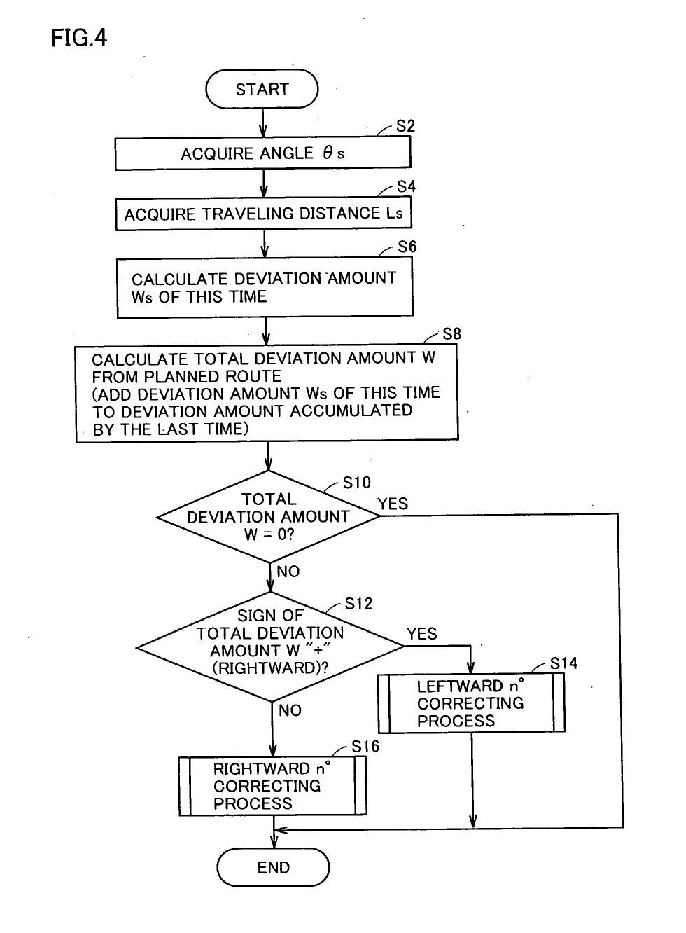

FIG. 4 is a flowchart showing a flow of the straight-ahead traveling controlling processes performed by CPU 10. The processes shown in the flowchart of FIG. 4 are previously stored as a program in memory 27 and a function of the straight-ahead traveling controlling processes is achieved when CPU 10 reads the program, for execution.

The processes shown in FIG. 4 are started every predetermined period (e.g., 100 ms) on the basis of the signal from timer 21 during the traveling control according to the straight-ahead traveling pattern. Unless otherwise specified, the pulse duties (hereinafter, referred to as “driving pulse duties”) for driving left driving wheel motor 60 and right driving wheel motor 61 designate the same driven state. The same driven state means that a ratio between an ON period (%) of the pulse duty of left driving wheel motor 60 (hereinafter, referred to as “left pulse duty”) and an ON period (%) of the pulse duty of right driving wheel motor 61 (hereinafter, referred to as “right pulse duty”) is 1:1.

With reference to FIG. 4, CPU 10 acquires an angle θs to a planned axis on the basis of the angular velocity outputted from gyro sensor 28 (step S2). In this embodiment, the “planned axis” refers to a straight line (axis) parallel to a planned route with reference to a reference position, i.e., a last-time position. Therefore, at a start point, for example, the planned axis and the planned route certainly agree with each other.

In other words, in step S2, angle θs indicative of a traveling direction from the reference position is calculated on the basis of the angular velocity outputted from gyro sensor 28. This angle θs is a value having a plus sign or a minus sign with reference to the planned axis.

Next, CPU 10 acquires a traveling distance Ls of cleaner 1 on the basis of the number of pulses outputted from left rotary encoder 22 and right rotary encoder 23, respectively (step S4). More specifically, traveling distance Ls is calculated by using the following equation (1).
Ls=a(L+R)/2 (1)

Herein, “a” represents a distance traveled by one pulse, “L” represents the number of pulses obtained from left rotary encoder 22, and “R” represents the number of pulses obtained from right rotary encoder 23.

Next, CPU 10 calculates a deviation amount Ws of this time (step S6). More specifically, deviation amount Ws of this time is calculated by using the following equation (2).
Ws=Sinθs×Ls (2)

Here, a principle of calculation of deviation amount Ws will be described by using FIG. 5. With reference to FIG. 5, because an interior angle θs' of a right triangle is a value equal to the angle θs acquired in step S2 (without consideration of the sign), deviation amount Ws can be calculated by the aforementioned equation (2). Incidentally, Sinθs is calculated from angle θs on the basis of a known function.

Next, CPU 10 calculates a total deviation amount W from the planned route (step S8). In other words, deviation amount Ws of this time is added to the deviation amount accumulated by the last time (total deviation amount of the last time).

Next, CPU 10 determines whether or not total deviation amount W calculated in step S8 is “0” (step S10). If it is determined that total deviation amount W is “0” (YES in step S10), it means that there is no deviation from the planned route and therefore the straight-ahead traveling controlling process of this time is finished.

On the other hand, if it is determined that total deviation amount W is not “0” in step S10 (NO in step S10), CPU 10 determines a type of a sign of total deviation amount W (step S12). If it is determined that the sign of total deviation amount W is “+”, i.e., if it is determined that cleaner 1 is deviating rightward from the planned route (YES in step S12), the program proceeds to step S14. On the other hand, if it is determined that the sign of total deviation amount W is “−”, i.e., if it is determined that cleaner 1 is deviating leftward from the planned route (NO in step S12), the program proceeds to step S16.

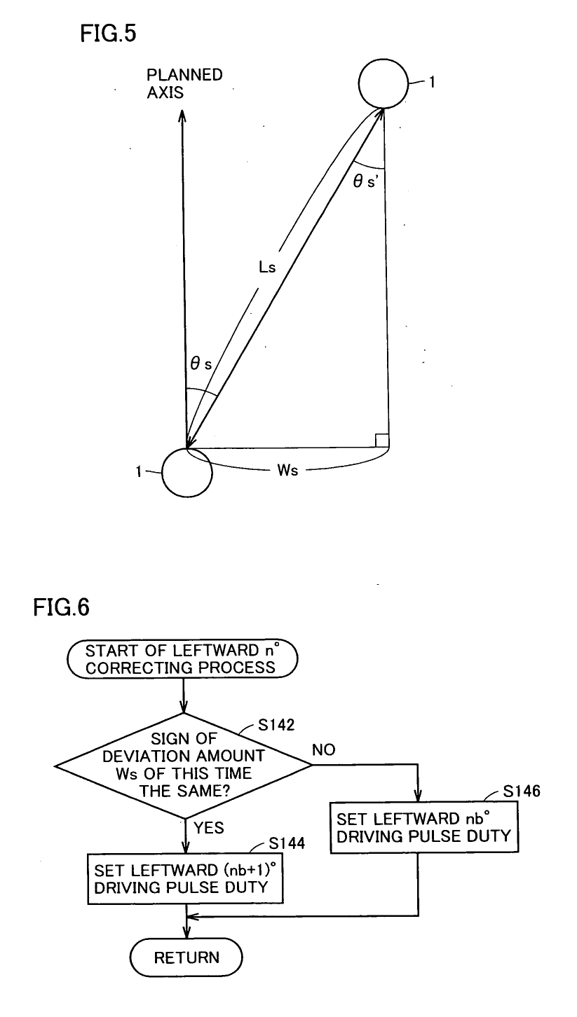

In step S14, CPU 10 performs a correcting process for correcting the course leftward through a rotation angle of n° (angle caused by a difference between the traveling distance of the left driving wheel and the traveling distance of the right driving wheel) per second, the course deviating rightward from the planned route. This process will be hereinafter referred to as “leftward n° correcting process”. The leftward n° correcting process will be described more specifically by using a flowchart in FIG. 6.

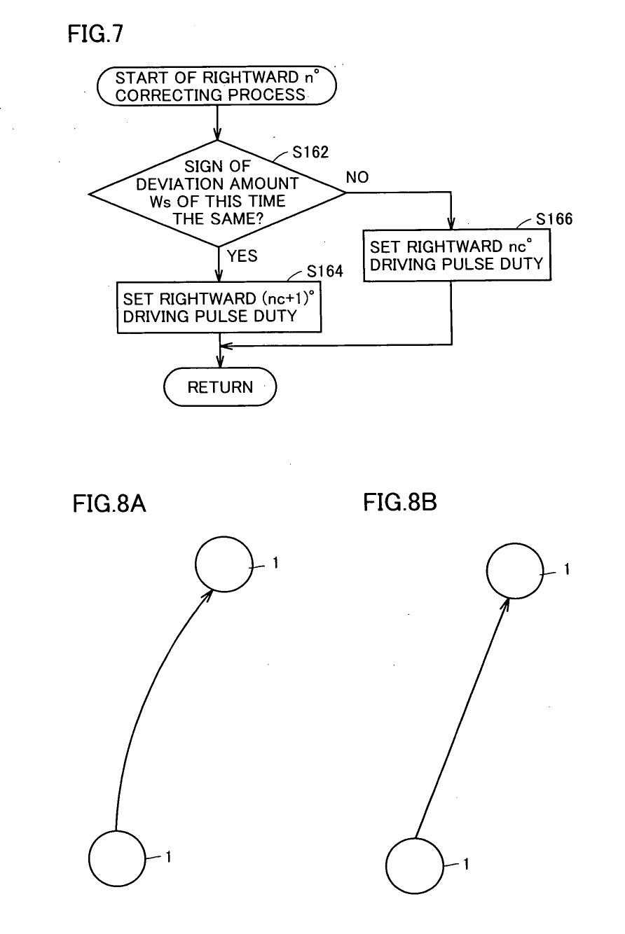

In step S16, CPU 10 performs a correcting process for correcting the route rightward through a rotation angle of n° per second, the route deviating leftward from the planned route (hereinafter, referred to as “rightward n° correcting process”). The rightward n° correcting process will be described more specifically by using a flowchart in FIG. 7.

First, the leftward n° correcting process shown in step S14 will be described.

With reference to FIG. 6, first, CPU 10 determines whether or not the sign of deviation amount Ws of this time and calculated in step S6 is the same as the sign (“+”) of total deviation amount W (step S142), where the same sign means the sign which is not “−” reverse to the sign of total deviation amount W. In other words, if the sign of deviation amount Ws of this time is “+” or if deviation amount Ws of this time is “0”, it is determined that the sign is the same as the sign (“+”) of total deviation amount W.

In step S142, if it is determined that the sign of deviation amount Ws of this time is the same as the sign (“+”) of total deviation amount W (YES in step S142), the program proceeds to step S144. On the other hand, if it is determined that the sign of deviation amount Ws of this time is not the same as the sign (“+”) of total deviation amount W (NO in step S142), the program proceeds to step S146.

In step S144, CPU 10 sets a driving pulse duty of “leftward (nb+1)°”. In other words, if a current (last-time) rotation angle is set at leftward nb° per second, the driving pulse duty corresponding to a rotation angle increased by 1° is set, for example. In this case, the rotation angle nb°: 0°, 1°, 2°, . . . . The leftward rotation angle of 0° corresponds to a case where total deviation amount W of the last time is “0”.

More specifically, the following driving pulse duties are set, for example. First, as the left pulse duty, a usual pulse duty (hereinafter, referred to as “reference duty”) (similar to that in a case with no deviation from the planned route) is set. Then, as the right pulse duty, a pulse duty with which the number of driving pulses of right driving wheel motor 61 (hereinafter, referred to as “right pulse number”) becomes greater than the number of driving pulses of left driving wheel motor 60 (hereinafter, referred to as “left pulse number”) by the number corresponding to (nb+1)° per second is set.

To put it more concretely, if a difference between the numbers of left and right pulses for performing travel through a rotation angle of 1° per second is Px in cleaner 1, for example, a pulse duty with which the right pulse number becomes greater than the left pulse number by (px/10) per 100 ms is set. Such a pulse number Px can be obtained by using gear ratios of driving wheel motors 60, 61 and the like.

Thus, motor control unit 51 drives left driving wheel motor 60 and right driving wheel motor 61 with the designated driving pulse duties and, as a result, cleaner 1 can gently change its traveling direction toward the planned route.

Next, in step S146, CPU 10 sets a driving pulse duty of “leftward nb°”. In other words, the driving pulse duty corresponding to the same rotation angle (leftward nb(1, 2, . . . )° per second) as current (last-time) one is set. It corresponds to a case where travel toward the planned route is being performed, though cleaner 1 is deviating rightward from the planned route. Therefore, in step S146, the driving pulse duty corresponding to the same rotation angle (nb°) as the last-time one is set.

In this way, motor control unit 51 drives left driving wheel motor 60 and right driving wheel motor 61 with the designated driving pulse duties and, as a result, cleaner 1 can return toward the planned route in a gentle arcuate curve.

When the process in step S144 or S146 is finished, the leftward n° correcting process is finished.

As described above, in this embodiment, only the right pulse duty is changed from the reference duty with respect to the left pulse duty as the reference duty. In this case, in step S144, the ON period (%) of the right pulse duty is increased. When the ON period (%) of the right pulse duty reaches a predetermined threshold value, the ON period (%) of the left pulse duty is reduced. In this way, only one of the driving pulse duties is modulated.

Next, the rightward n° correcting process shown in step S16 will be described.

With reference to FIG. 7, first, CPU 10 determines whether or not the sign of deviation amount Ws of this time and calculated in step S6 is the same as the sign (“−”) of total deviation amount W (step S162), where the same sign means the sign which is not “+” reverse to the sign of total deviation amount W. In other words, if the sign of deviation amount Ws of this time is “−” or if deviation amount Ws of this time is “0”, it is determined that the sign is the same as the sign (“−”) of total deviation amount W.

In step S162, if it is determined that the sign of deviation amount Ws of this time is the same as the sign (“−”) of total deviation amount W (YES in step S162), the program proceeds to step S164. On the other hand, if it is determined that the sign of deviation amount Ws of this time is not the same as the sign (“−”) of total deviation amount W (NO in step S162), the program proceeds to step S166.

In step S164, CPU 10 sets a driving pulse duty of“rightward (nc+1)°”. In other words, if a current (last-time) rotation angle is set at rightward nc° per second, the driving pulse duty corresponding to a rotation angle increased by 10 is set, for example. In this case, the rotation angle nc°: 0°, 1°, 2°, . . . . The rightward rotation angle of 0° corresponds to a case where the total deviation amount of the last time is “0”.

More specifically, the following driving pulse duty is set, for example. First, as the right pulse duty, a reference pulse duty is set. Then, as the left pulse duty, a pulse duty with which the left pulse number becomes greater than the right pulse number by the number corresponding to (nc+1)° per second is set.

Thus, motor control unit 51 drives left driving wheel motor 60 and right driving wheel motor 61 with the designated driving pulse duties and, as a result, the cleaner 1 can gently change its traveling direction toward the planned route.

Next, in step S166, CPU 10 sets a driving pulse duty of“rightward nc°”. In other words, the driving pulse duty corresponding to the same rotation angle (rightward nc(1, 2, . . . )° per second) as current (last-time) one is set. It corresponds to a case where travel toward the planned route is being performed, though cleaner 1 is deviating leftward from the planned route. Therefore, in step S166, the driving pulse duty corresponding to the same rotation angle (nc° ) as the last-time one is set.

In this way, motor control unit 51 drives left driving wheel motor 60 and right driving wheel motor 61 with the designated driving pulse duties and, as a result, cleaner 1 can return toward the planned route in a gentle arcuate curve.

When process in step S164 or S166 is finished, the rightward n° correcting process is finished.

In order to achieve the above process, a table which the rotation angle n (1°, 2°, 3°, . . . ) is corresponded to the driving pulse duty may be previously stored in memory 27 or the driving pulse duty may be calculated on the basis of an expression predetermined by experiments and the like.

With reference to FIG. 4 again, when step S14 (leftward n° correcting process) or step S16 (rightward n° correcting process) is finished, a series of straight-ahead traveling controlling processes is finished.

Because the straight-ahead traveling control is frequently performed (e.g., every 100 ms) in the aforementioned manner and the travel with a large angle difference is not performed, it is possible to perform the travel substantially kept in the planned route. Thus, cleaning along the planned route can be performed to achieve cleaning with high accuracy and with no region left without being cleaned.

Here, as described above, gyro sensor 28 is a device for detecting the angular velocity. Therefore, in step S2, by integrating the angular velocity by time, angle θs to the planned axis is calculated. For this reason, in a case of a linear motion as shown in FIG. 8B, the angular velocity cannot be detected by gyro sensor 28 and it is difficult to calculate angle θs with high accuracy in some cases. On the other hand, in a case of an arcuate motion as shown in FIG. 8A, a sensitivity of gyro sensor 28 for detecting the angular velocity is high and therefore it is possible to calculate the angle θs with high accuracy. In this embodiment, because the rotation angle is changed little by little as described above, the travel as shown in FIG. 8A is performed. As a result, according to this embodiment, it is possible to acquire angle θs with high accuracy in step S2 so that cleaner 1 can reliably return to the planned route.

Next, the straight-ahead movement control in this embodiment of the present invention will be described by way of specific examples.

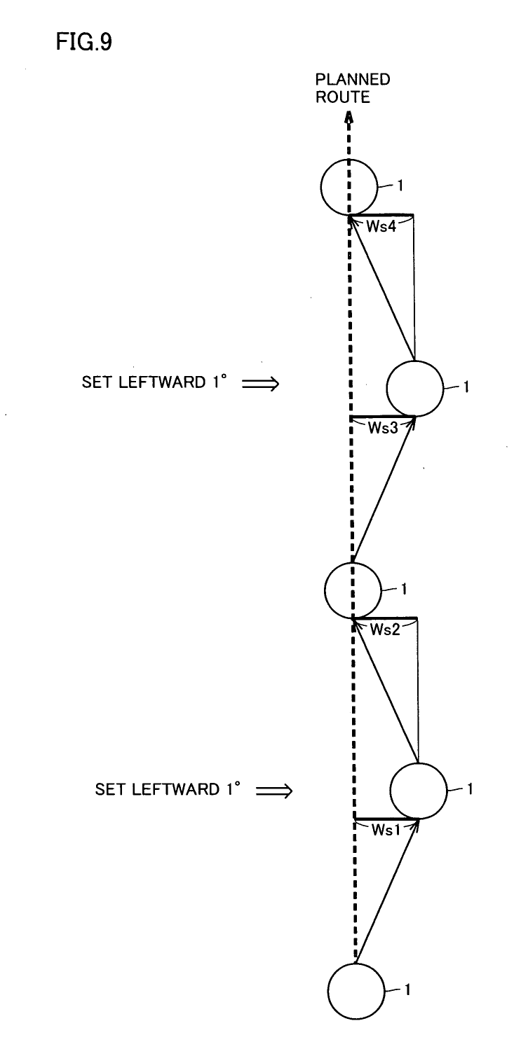

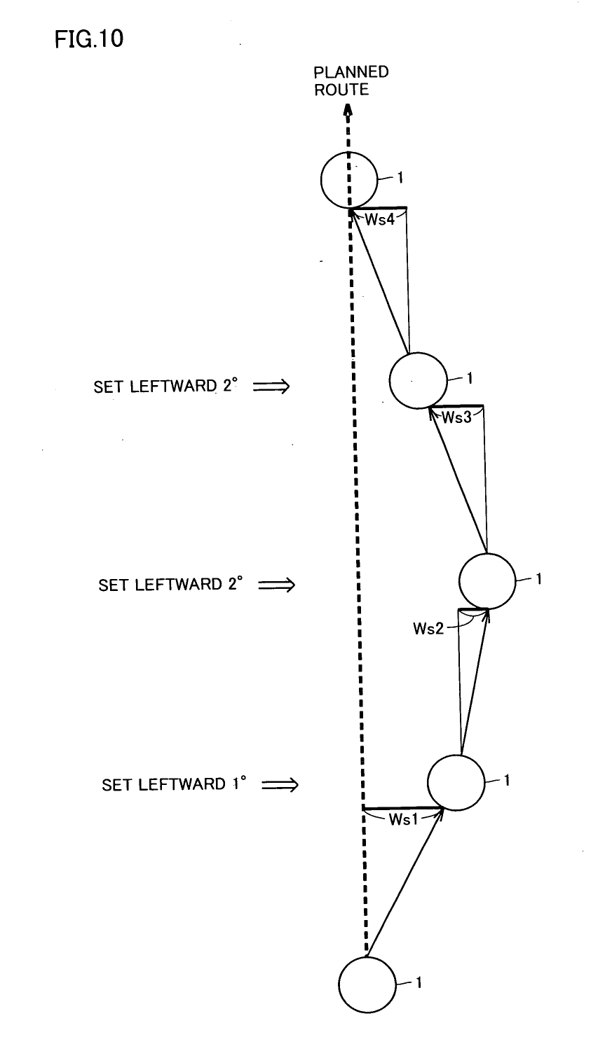

FIGS. 9 and 10 show examples of travel of cleaner 1 in cases of rightward deviation under the influence of the texture of the carpet, for example. FIG. 9 describes straight-ahead movement control when minute deviation is caused and FIG. 10 describes straight-ahead movement control when deviation is greater than that in the example shown in FIG. 9.

With reference to FIG. 9, first, cleaner 1 is positioned on the planned route. If a deviation amount of the first time is Ws1 (sign “+”), the total deviation amount is also Ws1 (sign “+”). Therefore, a driving pulse duty corresponding to a leftward rotation angle of 1° per second is set (step S144). Next, if an absolute value of a deviation amount Ws2 of the second time (sign “−”) is the same as that of Ws1, the total deviation amount becomes “0”. Therefore, in this case, the left pulse duty and the right pulse duty are reference duties, respectively (YES in step S10).

Likewise, if a deviation amount of the third time is Ws3 (sign “+”), the total deviation amount is also Ws3 (sign “+”). Therefore, a driving pulse duty corresponding to a leftward rotation angle of 1° per second is set (step S144). If an absolute value of a deviation amount Ws4 of the fourth time (sign “−”) is the same as that of Ws3, the total deviation amount becomes “0”. Therefore, in this case, the left pulse duty and the right pulse duty are reference duties, respectively (YES in step S10). Such control is repeated for the fifth time and thereafter.

Next, with reference to FIG. 10, cleaner 1 is first positioned on the planned route. If a deviation amount of the first time is Ws1 (sign “+”), the total deviation amount is also Ws1 (sign “+”). Therefore, a driving pulse duty corresponding to a leftward rotation angle of 1° per second is set (step S144). However, in FIG. 10, a sign of a deviation amount Ws2 of the second time (sign “+”) is the same as that of the total deviation amount. Therefore, a driving pulse duty corresponding to a leftward rotation angle of 2° per second is set (step S144).

A deviation amount of the third time is Ws3 (sign “−”) and the sign is not the same as that of the total deviation amount. Therefore, the driving pulse duty of “leftward 2°” (leftward rotation angle of 2° per second) which is the same as the last-time one is set (step S146). The total deviation amount of the fourth time is “0”. Therefore, in this case, the left pulse duty and the right pulse duty are reference duties, respectively (YES in step S10). Such control is repeated for the fifth time and thereafter.

As described above, irrespective of whether the influence of the texture of the carpet or the like is large or small, it is possible to control deviation from the planned route by performing the straight-ahead movement control in this embodiment. As a result, it is possible to reduce the region left without being cleaned. In other words, cleaner 1 in this embodiment can travel while kept in the planned route irrespective of a type of a floor face (a carpet, flooring, tatami mats, and the like). Therefore, it is unnecessary to change a control parameter according to the type of the floor face to save a user a troublesome operation.

Moreover, in the embodiment of the present invention, it is possible to perform travel kept in the planned route on the basis of detection amounts from gyro sensor 28 and rotary encoders 22, 23. Therefore, in the self-guided robot mounted with these sensors, it is possible to reliably enhance performance of the straight-ahead movement irrespective of performance of a motor driving system and the like.

Although initial adjustment at the time of shipment is necessary in conventional control with only pulse duties of left and right driving wheel motors 60, 61, such initial adjustment is unnecessary in the present invention, because the straight-ahead movement control is performed on the basis of the actual deviation amount from the planned route.

Although the case where cleaner 1 performs the map cleaning has been described as an example in the aforementioned embodiment, the present invention is not limited to the case of the map cleaning as long as the travel according to the straight-ahead traveling pattern is performed.

Although the rotation angle per second is increased by 1° in the aforementioned embodiment, it is also possible to increase the rotation angle by 2° per second or 0.5° per second, for example. Alternatively, the rotation angle may be fixed to a predetermined angle (e.g., 1° ).

In the aforementioned embodiment, whether or not the sign of deviation amount Ws is the same as the sign of total deviation amount W is determined every time (every 100 ms) in the straight-ahead movement control and the driving pulse duty corresponding to the rotation angle increased by 1° is set in a case of the same sign. However, the rotation angle may not be increased every time. For example, such determination may be made once every plurality of times, the driving pulse duty corresponding to the same rotation angle may be set three times, or the rotation angle may be increased only in the case of the same sign.

Although angle θs to the planned axis is obtained by integrating the angular velocity detected by gyro sensor 28 by time in this embodiment, angle θs may not be obtained by this method. For example, a sensor for directly detecting angle θs to the planned axis may be provided instead of gyro sensor 28.

Although the present invention has been described by using cleaner 1 in the aforementioned embodiment, the present invention is not limited to the cleaning robot as long as the traveling control according to the straight-ahead traveling pattern is performed.

The present invention can also provide, as a program, a straight-ahead movement controlling method performed by the self-guided (cleaning) robot of the present invention. Such a program can be provided as a program product so as to be recorded in an optical medium such as a CD-ROM (Compact Disc-ROM) or a computer readable recording medium such as a memory card. Moreover, this program can be also provided by download through a network.

The program product to be provided is loaded on a program storage unit such as memory 27, for execution. Herein, the program product includes a program itself and a recording medium having the program recorded therein.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A self-guided cleaning robot for traveling with a predetermined traveling pattern, comprising:
a suction unit for performing a sucking operation for cleaning;
an angle detection unit for detecting an angle indicative of a traveling direction from a reference position;
a distance detection unit for detecting a traveling distance from said reference position;
a travel unit for allowing a main body to move;
a traveling drive unit for driving said travel unit for traveling; and
a route deviation amount calculation unit for calculating a route deviation amount from a planned route when said traveling pattern is a straight-ahead traveling pattern for traveling along said planned route, wherein
said planned route represents a route from a start point to a target point with a straight line,
said route deviation amount calculation unit includes:
an acquisition unit for acquiring detection amounts every predetermined time from said angle detection unit and said distance detection unit, respectively; and
an axis deviation amount calculation unit for calculating an axis deviation amount from a planned axis for said every predetermined time on the basis of said acquired detection amounts,
said planned axis represents a straight line parallel to said planned route with reference to said reference position,
said route deviation amount calculation unit adds said axis deviation amount successively to calculate said route deviation amount,
the self-guided cleaning robot further comprises a traveling control unit for controlling the driving of said traveling drive unit on the basis of said calculated route deviation amount, and
said traveling control unit includes: a determination unit for determining a type of a sign of said route deviation amount; and a setting unit for setting a rotation angle for traveling toward said planned route on the basis of the type of said sign, and controls the driving of said traveling drive unit according to said set rotation angle.

2. A self-guided robot for traveling with a predetermined traveling pattern, comprising:
an angle detection unit for detecting an angle indicative of a traveling direction from a reference position;
a distance detection unit for detecting a traveling distance from said reference position;
a travel unit for allowing a main body to move;
a traveling drive unit for driving said travel unit for travel;
a route deviation amount calculation unit for calculating a route deviation amount from a planned route on the basis of detection amounts from said angle detection unit and said distance detection unit when said traveling pattern is a straight-ahead traveling pattern for traveling along said planned route; and
a traveling control unit for controlling the driving of said traveling drive unit on the basis of said calculated route deviation amount.

3. The self-guided robot according to claim 2, further comprising:
a suction unit for performing a sucking operation for cleaning.

4. The self-guided robot according to claim 2, wherein
said route deviation amount calculation unit includes:
an acquisition unit for acquiring detection amounts every predetermined time from said angle detection unit and said distance detection unit, respectively; and
an axis deviation amount calculation unit for calculating an axis deviation amount from a planned axis for said every predetermined time on the basis of said acquired detection amounts,
said planned axis represents a straight line parallel to said planned route with reference to said reference position, and
said route deviation amount calculation unit adds said axis deviation amount successively to calculate said route deviation amount.

5. The self-guided robot according to claim 2, wherein
said traveling control unit includes a type determination unit for determining a type of a first sign of said route deviation amount calculated by said route deviation amount calculation unit.

6. The self-guided robot according to claim 5, wherein
said traveling control unit further includes a setting unit for setting a rotation angle for traveling toward said planned route on the basis of the type of said first sign determined by said type determined unit, and controls the driving of said traveling drive unit according to said set rotation angle.

7. The self-guided robot according to claim 5, wherein
said traveling control unit further includes: a determination unit for determining whether or not the type of a second sign of said axis deviation amount is the same as the type of said first sign; and an increase processing unit for increasing a rotation angle for traveling toward said planned route when said determination unit determines that the type of said first sign and the type of said second sign are the same, and controls the driving of said traveling drive unit according to said increased rotation angle.

8. The self-guided robot according to claim 2, wherein
said travel unit includes a left travel unit provided to a left side of said main body and a right travel unit provided to a right side of said main body,
said traveling drive unit includes a left traveling drive unit for driving said left travel unit and a right traveling drive unit for driving said right travel unit, and
said traveling control unit changes a driving state of either one of said left traveling drive unit and said right traveling drive unit.

9. The self-guided robot according to claim 2, wherein
said angle detection unit includes a gyro sensor, and
said distance detection unit includes a rotary encoder provided in said traveling drive unit.

10. The self-guided robot according to claim 2, wherein
said planned route represents a route from a start point to a target point with a straight line.

11. A program product for performing a method for controlling travel of a self-guided robot, wherein
the method comprises the steps of:
acquiring every predetermined time an angle indicative of a traveling direction from a reference position and a traveling distance from said reference position, respectively, when the traveling pattern of said self-guided robot is a straight-ahead traveling pattern for traveling along a planned route;
calculating an axis deviation amount from a planned axis for said every predetermined time on the basis of said angle and said traveling distance, said planned axis representing a straight line parallel to said planned route with reference to said reference position;
calculating a route deviation amount from said planned route by successively adding said axis deviation amount;
determining a type of a sign of said route deviation amount; and
setting a rotation angle for traveling toward said planned route on the basis of the type of said sign of said route deviation amount to control the driving of a traveling drive unit according to said set rotation angle.
